(19) United States
(12) Patent Application Publication
(10) Pub. No.: US 2019/0103903 A1
(43) Pub. Date: Apr. 4, 2019

(54) Codebook Designs To Support ULA And Non-ULA Scenarios

(71) Applicant: MediaTek Inc., Hsinchu City (TW)

(72) Inventor: Weidong Yang, San Diego, CA (US)

(21) Appl. No.: 16/149,004

(22) Filed: Oct. 1, 2018

Related U.S. Application Data
(63) Continuation-in-part of application No. 16/136,215, filed on Sep. 19, 2018.
(60) Provisional application No. 62/566,793, filed on Oct. 2, 2017.

(51) Int. Cl. H04B 7/0456

(52) U.S. Cl. CPC H04B 7/0456

(57) ABSTRACT

Various solutions with respect to codebook-based uplink transmission in wireless communications are described. A user equipment (UE) generates a codebook comprising a plurality of precoders. The UE processes information using the codebook and transmits the processed information to a network node of a wireless network. In generating the codebook, the UE selects a candidate precoder from a single-stage codebook or a dual-stage codebook and performs a permutation on the candidate precoder.

### CROSS REFERENCE TO RELATED PATENT APPLICATION(S)

The present disclosure is part of a non-provisional application claiming the priority benefit of U.S. Patent Application Nos. 62/566,793, filed on 2 Oct. 2017, and is also a continuation-in-part (CIP) of U.S. patent application Ser. No. 16/136,215, filed on 19 Sep. 2018, the contents of which are incorporated by reference in their entirety.

### TECHNICAL FIELD

The present disclosure is generally related to wireless communications and, more particularly, to codebook-based uplink (UL) transmission in wireless communications.

### BACKGROUND

Unless otherwise indicated herein, approaches described in this section are not prior art to the claims listed below and are not admitted as prior art by inclusion in this section.

Compared with downlink (DL) codebook design, there are significant differences in terms of network node implementation and deployment scenarios. Due to different gain set points, the issue of relative phase discontinuity (RPD) has been identified in Long-Term Evolution (LTE) mobile communication systems. With limited form factor, and given the immediate radiation/propagation environment is susceptible to effects such as hand-holding, rich local scatter and the like, possible antenna gain difference can also exist on the user equipment (UE) side. When multiple panels are used at a UE, there can be also the frequency coherence issue such as non-common mode phase noise. To complicate the situation even more, in 5^{th}-Generation (5G) or New Radio (NR) mobile communication systems, both discrete Fourier transformation OFDM (DFT-OFDM) and cyclic-prefix orthogonal frequency-division multiplexing (CP-OFDM) waveforms are supported, and they have different requirements on the precoder in terms of peak-to-average power ratio (PAPR) preserving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure proposes a number of solutions, schemes, methods and apparatus pertaining to codebook-based uplink transmission in wireless communications. Under various schemes proposed herein, a codebook may be designed to be robust for diverse scenarios. The codebook may cover a number of targeted codebooks which were optimized for specific antenna configurations and/or scenarios (e.g., Rel-8 DL 4Tx rank 2 codebook, rank 2 mutually unbiased bases (MUB) extension from Rel-10 UL 4Tx rank 1 codebook and Rel-15 DL NR 4Tx rank 2 codebook). It is believed that the proposed solutions, schemes, methods and apparatus may reduce transmission overhead, improve system performance, and reduce power consumption by UEs.

In one aspect, a method may involve a processor of a user equipment (UE) constructing a codebook comprising a plurality of precoders. The method may also involve the processor processing information using the codebook. The method may further involve the processor transmitting the processed information to a network node of a wireless network. In constructing the codebook, the method may involve the processor selecting a candidate precoder from a single-stage codebook or a dual-stage codebook and performing a permutation on the candidate precoder.

In one aspect, an apparatus may include a transceiver and a processor coupled to the transceiver. The transceiver may be capable of wirelessly communicating with a network node of a wireless network. The processor may be capable of: (a) constructing a codebook comprising a plurality of precoders; (b) processing information using the codebook; and (c) transmitting, via the transceiver, the processed information to a network node of a wireless network. In constructing the codebook, the processor may be capable of selecting a candidate precoder from a single-stage codebook or a dual-stage codebook and performing a permutation on the candidate precoder.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies wherever applicable such as, for example and without limitation, LTE, LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example scenarios in accordance with the present disclosure.

FIG. 2 is a diagram of an example scenario in accordance with the present disclosure.

FIG. 3 is a diagram of an example scenario in accordance with the present disclosure.

FIG. 4 is a diagram of an example scenario in accordance with the present disclosure.

FIG. 5 is a diagram of an example wireless communication environment in accordance with an implementation of the present disclosure.

FIG. 6 is a flowchart of an example process in accordance with an implementation of the present disclosure.

Each of FIG. 7A, FIG. 7B, FIG. 7C and FIG. 7D shows example rank 1 codewords in accordance with an implementation of the present disclosure.

Each of FIG. 8A, FIG. 8B, FIG. 8C, FIG. 8D, FIG. 8E, FIG. 8F, FIG. 8G and FIG. 8H shows example rank 2 codewords in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to codebook-based uplink transmission in wireless communications. According to the present disclosure, a number of possible solutions may be implemented separately or jointly. That is, although these possible solutions may be described below separately, two or more of these possible solutions may be implemented in one combination or another.

Under various proposed schemes in accordance with the present disclosure, a codebook may be constructed by selecting a candidate precoder from a single-stage codebook or a dual-stage codebook and then performing one or more permutations on the candidate precoder. In performing the one or more permutations on the candidate precoder, multiple permutations that cover a plurality of mutually unbiased bases (MUBs), a plurality of codebooks specified in 3^{rd}-Generation Partnership Project (3GPP) specifications, or a combination thereof, may be utilized.

### NR Uplink Rank 1 Codebook Design

Under a proposed scheme in accordance with the present disclosure, to support both uniform linear array (ULA) and non-ULA antenna configurations, a dual-stage codebook structure may be adopted with the codebook having codewords from LTE Rel-10 UL four-transmitter (4Tx) codebook and NR Rel-15 DL 4Tx codebook.

For Construction 1, let N₁=2, with N₂=1, O₁=4 and L=2, the following may be defined:

$${φ}_{n} = {e}^{j \frac{π n}{2}} , {u}_{m} = [ \begin{matrix}1 \\ {e}^{j \frac{2 π n}{{O}_{1} {N}_{1}}}\end{matrix} ] .$$

In the design:

$$Let {B}_{n} = [ \begin{matrix}{u}_{n} & {u}_{n + \frac{{O}_{1} {N}_{1}}{2}}\end{matrix} ] = [ \begin{matrix}1 & \\ & {e}^{j \frac{2 π n}{{O}_{1} {N}_{1}}}\end{matrix} ] [ \begin{matrix}1 & 1 \\ 1 & - 1\end{matrix} ]$$

$$then {W}_{n}^{( 1 )} = [ \begin{matrix}{B}_{n} & \\ & {B}_{n}\end{matrix} ] and {W}_{i , j , n}^{( 2 )} = [ \begin{matrix}{e}_{i} \\ {φ}_{n} {e}_{j}\end{matrix} ] .$$

A rank 1 precoder may be given by Wₖ⁽¹⁾W_{i,j,n}⁽²⁾, where 0≤k≤N₁O₁/2−1=3, with 1≤i, j≤2 and 0≤n≤3. It is noteworthy that (i,j)=(1,1),(1,2),(2,1),(2,2), and ϕₙ takes a value from 1, j, −1, −j, and eᵢ is a L×1 vector with 1 at element i and zeros elsewhere. It is also noteworthy that there are sixteen rank 1 precoders (with the first sixteen precoders in Rel-10 4Tx UL codebook being for port combining) from Rel-10 4Tx UL codebook, and thirty-two rank 1 precoders from Rel-15 NR downlink (DL) 4Tx codebook with L=1. Collecting those vectors together, forty unique precoders (eight precoders being common in both codebooks) may be obtained.

It is further noteworthy that the allowed range for each parameter can be restricted with codebook subset restriction (CSR). To support the same port combining rank 1 precoders from Rel-10 UL 4Tx codebook, some CSRs may be considered. For instance, a beam group restriction of k=0,2 (e.g., k≠1,3) may be taken, leading to one bit saving for signaling on W₁. Additionally, the allowed co-phasing values may depend on the beam selection pairs k=0 and k=2. For k=0, for beam selection (i,j)=(1,1) or (2,2), co-phasing values from {j,−j} are allowed; and for beam selection (i,j)=(1,2),(2,1), co-phasing values from {1,−1} are allowed. For k=2, for beam selection (i,j)=(1,2) or (2,1), co-phasing values from {j,−j} are allowed; and for beam selection (i,j)=(1,1),(2,2), co-phasing values from {(1,−1} are allowed. Accordingly, one bit saving can be achieved for signaling on W₂.

To support the same rank 1 precoders as from Rel-15 DL 4Tx codebook, a CSR may be taken. Specifically, beam selection (i,j) may be limited to (1,1),(2,2). For instance, (1,2) and (2,1) may not be allowed.

Each of FIG. 7A, FIG. 7B, FIG. 7C and FIG. 7D shows example rank 1 codewords in accordance with an implementation of the present disclosure.

### NR Uplink Rank 2 Codebook Design

The chordal distance between two precoders A and B is given by the norm of the matrix AA^{H}-BB^{H}, where the subscript H is for the Hermitian operator. In the present disclosure, the phrase “chordal-distance equivalent” is used to refer to two codewords in an event that their chordal distance is 0. Additionally, a first codebook (codebook 1) may be deemed to “cover” a second codebook (codebook 2) in an event that, for any codeword in codebook 2, there is a chordal-distance equivalent codeword in codebook 1. Moreover, the phrase “chordal-distance equivalent” is used to refer to two codebooks in an event that, for any codeword in either of the two codebooks, there is a chordal-distance equivalent codeword in another codebook. In other words, they may cover each other. Thus, it can be verified that Rel-8 DL 4Tx rank 2 codebook, the rank 2 MUB extension from Rel-10 UL 4Tx rank 1 codebook and the Rel-15 DL NR 4Tx rank 2 codebook are completely covered by the designed codebook in accordance with the present disclosure described herein.

Under a proposed scheme in accordance with the present disclosure, four vectors may be defined as follows:

$${v}_{1} = [ \begin{matrix}1 \\ 1\end{matrix} ] , {v}_{2} = [ \begin{matrix}1 \\ - 1\end{matrix} ] , {v}_{3} = [ \begin{matrix}1 \\ {e}^{j π / 4}\end{matrix} ] , {v}_{4} = [ \begin{matrix}1 \\ - {e}^{j π / 4}\end{matrix} ] .$$

At a base station/network node, as the antenna form factor is less an issue than that at a UE, typically ULA is assumed for antennas/antenna elements for one polarization, and a two-dimensional (2D) array of cross-pol antenna pairs is often assumed as in frequency division multiple-input-and-multiple-output (FD-MIMO).

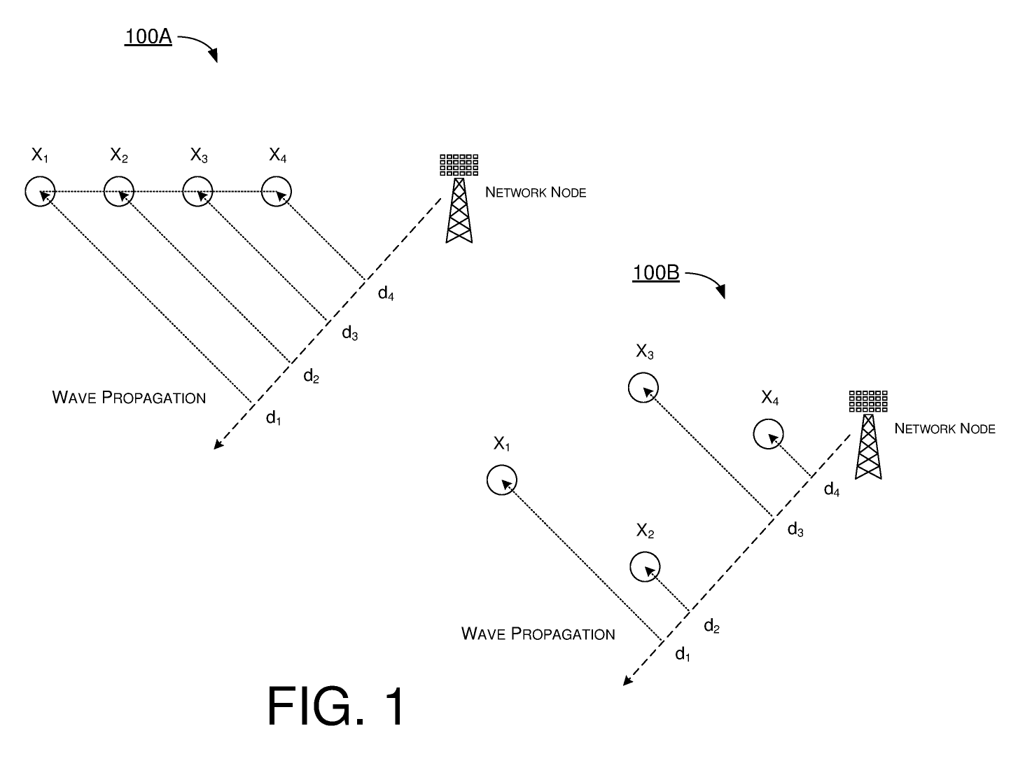

FIG. 1 illustrates example scenarios 100A and 100B in accordance with the present disclosure. Referring to FIG. 1, scenario 100A depicts an example ULA response, where a signal emitting from a signal source impinges a uniform linear array. The signal model is formulated for receive as often used in array signal processing. The signal model for transmit can be formulated similarly. The phase difference among receivers xᵢ, 1≤i≤N, may be determined by the projections dᵢ of antenna positions to the wave propagation direction. The array response vector may be determined by the phase profile d₁, d₂, Λ and d_{N}:

$$P ( {d}_{1} , {d}_{2} , Λ , {d}_{N} ) = [ \begin{matrix}{e}^{j 2 π \frac{{d}_{1} - {d}_{2}}{λ}} \\ {e}^{j 2 π \frac{{d}_{2} - {d}_{1}}{λ}} \\ M \\ {e}^{j 2 π \frac{{d}_{N} - {d}_{1}}{λ}}\end{matrix} ]$$

In the case of ULA, as dᵢ has a uniform difference (e.g., dᵢ₊₁−dᵢ=Δ, with Δ being the antenna spacing), the phase difference is also uniform. DFT beams may be used to match the phase difference. Thus, high-gain coherent transmissions and receptions may be achieved.

However, at the UE side, an irregular antenna placement may arise as shown in scenario 100B. In general, the differences between neighboring projections dᵢ may be non-uniform, and it may be difficult to use any DFT beam to approximate P(d₁,d₂,Λ,d_{N}) directly. Yet, the phase profile may be better approximated by re-arranging d₁, d₂, Λ and d_{N}. For example, for a particular antenna placement, it may be possible to approximate P(d_{N},d₁,d₂,Λ,d_{N-1}) well with a DFT beam while P(d₁,d₂,Λ,d_{N}) is not well approximated by any DFT beam. In other words, a premutation of the antenna ports in this case may be helpful.

In general, besides antenna port permutation, some kind of phase rotation may be considered, as described below. Let:

$${P}_{k} = {\prod }_{k} = [ \begin{matrix}{r}_{k , 1} & & & \\ & {r}_{k , 2} & & \\ & & O & \\ & & & {r}_{k , 4}\end{matrix} ]$$

Here, Πₖ denotes a permutation matrix, and |r_{k,n}|=1, 1≤n≤N specifies a phase rotation for antenna ports. This consideration provides motivation to define a larger codebook by permuting the codewords from a first codebook in multiple ways. For any type of a first codebook, such a construction may be conducted.

Specifically, for a dual-stage codebook, with a first codebook, W₁^{(k)}W₂^{(m)}, with k being a generic index (e.g., k=(i_{1,1},i_{1,2},i_{1,3})), m being a generic index (e.g., m=(i₂,n)) and i_{1,1},i_{1,2},i_{1,3},i₂,n as in TS 38.214 (V.0.1.2 September 2017), then a second and larger codebook may be constructed through Pₚ_{₁}W₁^{(k)}W₂^{(m)}, where 1≤p₁≤P. Let:

$${P}_{k} = {\prod }_{k} = [ \begin{matrix}{r}_{k , 1} & & & \\ & {r}_{k , 2} & & \\ & & O & \\ & & & {r}_{k , N}\end{matrix} ]$$

Here, Πₖ denotes a permutation matrix, and |r_{k,n}|=1, =1, 1≤n≤N specifies a phase rotation for antenna ports, which also includes no phase rotation (e.g., r_{k,1}=Λ=r_{k,N}=1). It is noteworthy that the second codebook has P times as many codewords as the first codebook. The term “shuffling” herein refers to the procedure of generating a second codebook from a first codebook, and the procedure includes permutation and/or phase rotation of antenna ports.

In an event that the targeted irregular antenna placements are known, it may be possible to identify the required parameters for shuffling. As there can be many different antenna placements at UEs, instead of identifying shuffling parameters for specific antenna placements, one criterion may be used to identify the shuffling parameters. In particular, the criterion may be that the resulted larger (second) codebook includes as many entries as possible from the MUB design or Rel-8 DL codebook design, where the Rel-8 DL codebook is a robust codebook in terms of antenna spacing.

Under a proposed scheme in accordance with the present disclosure, for rank 1, with NR rel-15 4Tx DL codebook (with L=1) being the first codebook with permutations (1,2,3,4) and (1,3,2,4) applied, the resultant second and enlarged codebook covers all except four codebooks from Rel-8 DL 4Tx codebook. This shows that the proposed scheme is applicable to not only rank 2 but also codebooks at other ranks. For rank 2, with NR Rel-15 4Tx DL codebook with L=1) being the first codebook with permutations (1243), (1324), (1423) applied, the resultant second and enlarged codebook has 128 codewords. The constructed codebook covers all codewords from Rel-15 4Tx DL codebook, Rel-8 4Tx codebook as well as Rel-10 UL 4Tx codebook.

Under the proposed scheme, the first codebook may be based on beam vector combination design, and the enlarged codebook may be based on the use of permutation matrices.

The aggregation of SRS resources along with PMI(s) may be used to indicate the wideband or subband precoders for UL transmissions. For instance, SRS resources 1, 2, 3 and 4 may be aggregated to be used together with a 4Tx codebook. A single implicit mapping from those SRS resources to codebook antenna ports may be assumed. In view of the above, it may not be sufficient to assume a single order for SRS resources to provide good support to diverse antenna placement scenarios.

Under a proposed scheme in accordance with the present disclosure, there may be a number of approaches to provide specification support for the codebook through shuffling, as described below.

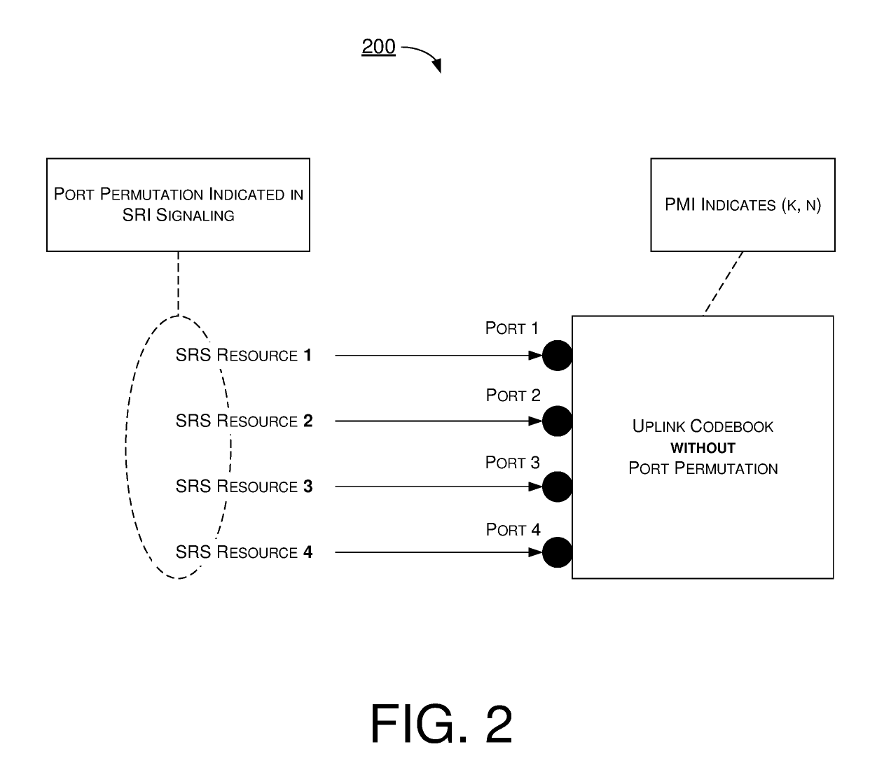

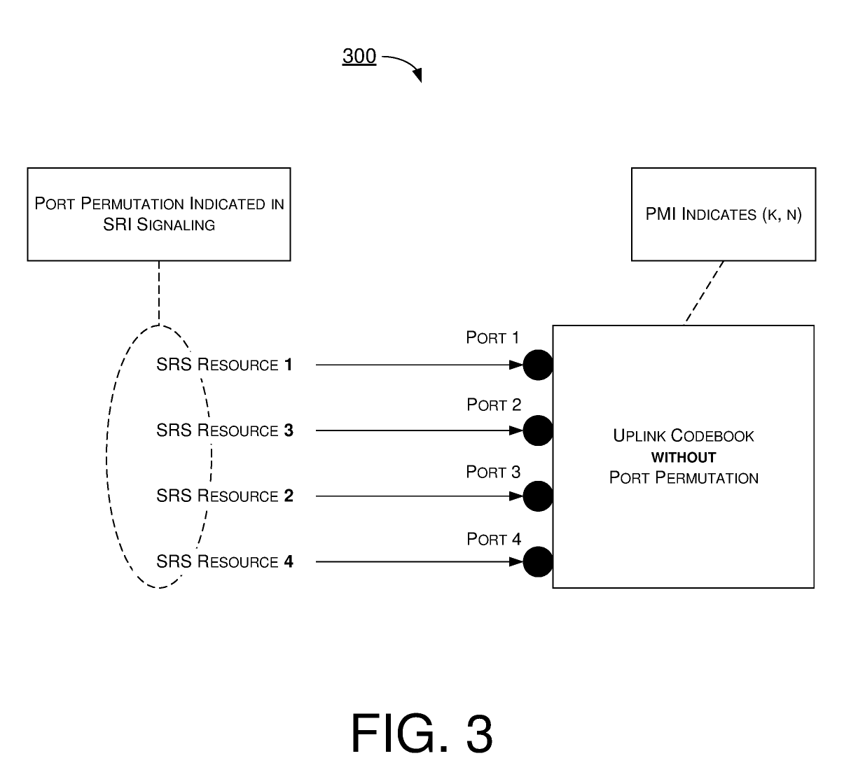

Under a first approach, in an event that SRS resources with a single port for each SRS resource are used for an UL codebook, with the order of SRS resources mapped to the codebook ports being indicated to a UE, then it may be sufficient to use the first codebook (and no other codebooks) for PMI definition. For example, the network node (e.g., gNB) may indicate that SRS resources 1, 2, 3 and 4 are used for a signaled PMI. In one case the network node may signal that SRS resources 1, 2, 3 and 4 are mapped to ports 1, 2 3 and 4 (e.g., through the signaling of a list of SRS resource indicators (SRIs) or index to that list: (1, 2, 3, 4)). In another case, the network node may signal that SRS resources 1, 3, 2 and 4 are mapped to ports 1, 2, 3 and 4 (e.g., through the signaling of a list of SRIs or index to that list: (1, 3, 2, 4)). Two illustrative examples are depicted in FIG. 2 and FIG. 3. FIG. 2 illustrates an example scenario 200 of port permutation (1234) indication from SRI signaling. FIG. 3 illustrates an example scenario 300 of port permutation (1324) indication from SRI signaling.

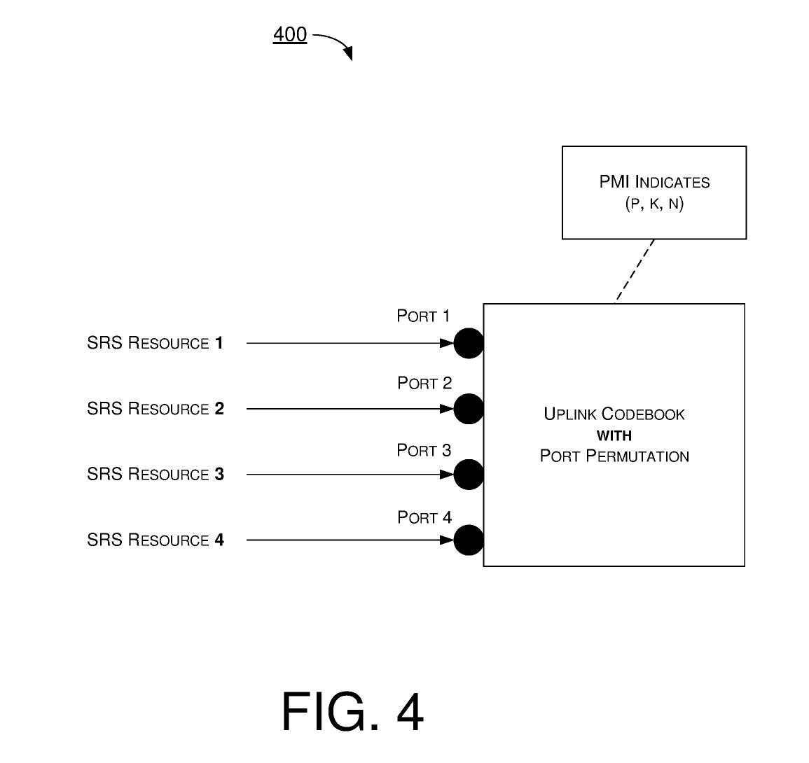

Under a second approach, in an event that SRS resources with a single port for each SRS resource are used for an UL codebook, with the order of SRS resources mapped to the codebook ports being fixed, then indication of the permutation of the SRS resources may be necessary for PMI definition. For example, the network node (e.g., gNB) may indicate that SRS resources 1, 2, 3 and 4 are used for the signaled PMI. In one design option, the network node may signal the permutation of SRS resources (e.g., (1, 2, 3, 4) or (1, 3, 2, 4) to the UE), and the PMI may be for the first codebook. In another design option, as shown in FIG. 4, the permutation may be integrated in the PMI definition, and the PMI may be for the second codebook. FIG. 4 illustrates an example scenario 400 of port permutation as an integral part of the codebook definition.

Under a third approach, in an event that a single SRS resource with multiple ports is used for an UL codebook, indication of the permutation of SRS ports may be necessary for PMI definition. For example, the network node (e.g., gNB) may indicate an SRS resource with ports 1, 2, 3 and 4 for a signaled PMI. In one design option, the network node may signal the permutation of SRS ports (e.g., (1, 2, 3, 4) or (1, 3, 2, 4) to the UE), and the PMI may be for the first codebook. In another design option, the permutation of SRS ports may be integrated in the PMI definition, and the PMI may be for the second codebook.

Under the proposed scheme, the permutation of SRS resources/SRS ports may be indicated through radio resource control (RRC) signaling or media access control (MAC) control element (CE). Such indication may be provided along with other precoding matrix indicator (PMI) parameters such as those for W₁.

Under the proposed scheme, there may be numerous approaches to indicating the permutations of SRS resources or antenna ports. For instance, a codebook construction may be pursued as an antenna re-indexing, and necessary adaptation to the case of using SRS resources may be clear. Accordingly, permutation matrices may be introduced in the codebook construction. From the dual-stage codebook W₁^{(k)}W₂^{(m)}, with k being a generic index (e.g., k=(i_{1,1},i_{1,2},i_{1,3})), m being a generic index (e.g., m=(i₂,n)) and i_{1,1},i_{1,2},i_{1,3},i₂,n as in TS 38.214 (V.01.2 Sep. 2017), a permutated codebook Pₚ_{₁}W₁^{(k)}W₂^{(m)} may result, where 1≤p₁≤P and Pₚ_{₁} is a permutation matrix applied to the rank 2 precoders.

In this case, a beam group may be determined by k and the permutation matrix index p₁. The permutation matrix index may be determined in a long-term basis (e.g., through RRC signaling and/or MAC CE as part of CSR or independent of CSR), so the feedback overhead of the enlarged codebook remain unchanged compared to the original codebook (e.g., NR DL 4Tx codebook). With the above example, the Rel-8 rank 2 4Tx codebook and Rel-15 NR rank 2 4Tx codebook are covered by the proposed design.

It is noteworthy that, for other ranks, the same or different permutation matrices may be identified. In summary, using permutation matrices to an existing or a first codebook to obtain an enlarged codebook may be treated as a generic way to handle irregular antenna configurations. Moreover, in various codebook constructions described herein, a number of permutation matrices Pₚ_{₁} may be used to obtain an enlarged codebook, with Pₚ_{₁}DₙC₂^{(k)}. For illustrative purposes and without limiting scope of the present disclosure, three example constructions (Construction A, Construction B and Construction C) are provided below.

### Illustrative Example Construction A

With the NR DL 4Tx codebook with L=1, the following permutation matrices may be applied:

$${P}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$

denoted as permutation (1234);

$${P}_{2} = [ \begin{matrix}0 & 0 & 0 & 0 \\ 0 & 1 & 0 & 0 \\ 0 & 0 & 0 & 1 \\ 0 & 0 & 1 & 0\end{matrix} ] ,$$

denoted as permutation (1243);

$${P}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$

denoted as permutation (1324); and

$${P}_{4} = [ \begin{matrix}1 & 0 & 0 & 0 \\ 0 & 0 & 0 & 1 \\ 0 & 1 & 0 & 0 \\ 0 & 0 & 1 & 0\end{matrix} ] ,$$

denoted as permutation (1423).

Given the following, 128 rank 2 codewords may be generated:

$${u}_{m} = [ \begin{matrix}1 \\ {e}^{j \frac{2 π n}{{O}_{1} {N}_{1}}}\end{matrix} ] , {B}_{k} = [ \begin{matrix}{u}_{k} & {u}_{k + \frac{{O}_{1} {N}_{1}}{2}}\end{matrix} ] , \\ {W}_{k}^{( 1 )} = [ \begin{matrix}{B}_{k} & \\ & {B}_{k}\end{matrix} ] , 0 \leq k \leq {N}_{1} {O}_{1} - 1.$$

$${W}_{n}^{( 2 )} ∈ \{ [ \begin{matrix}{e}_{1} & {e}_{1} \\ φ {e}_{1} & - φ {e}_{1}\end{matrix} ] , [ \begin{matrix}{e}_{1} & {e}_{2} \\ φ {e}_{1} & - φ {e}_{2}\end{matrix} ] , φ = 1 , j . \}$$

### Illustrative Example Construction B

In existing NR codebook design, orthogonal beam groups are used to construct codewords for ranks higher than rank 1. For each layer, the same beam vector is used for both polarizations subject to possible phase adjustment. In a proposed codebook in accordance with the present disclosure, different beam vectors may be used for different polarizations for each layer.

Let N₁=2, N₂=1 and O₁=4, the following may be defined:

PₚWₖ⁽¹⁾Wₙ⁽²⁾,0≤k≤N₁O₁−1.

Here, Pₚ (where p=1,2) may be given by the following:

$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] .$$

The definition of Wₖ⁽¹⁾ may be the same as in NR DL 4Tx codebook, given the following:

$${u}_{m} = [ \begin{matrix}1 \\ {e}^{j \frac{2 π n}{{O}_{1} {N}_{1}}}\end{matrix} ] , {B}_{k} = [ \begin{matrix}{u}_{k} & {u}_{k + \frac{{O}_{1} {N}_{1}}{2}}\end{matrix} ] , \\ {W}_{k}^{( 1 )} = [ \begin{matrix}{B}_{k} & \\ & {B}_{k}\end{matrix} ] , 0 \leq k \leq {N}_{1} {O}_{1} - 1.$$

There may be two alternatives for Wₙ⁽²⁾, namely alternative 1 (Alt 1) and alternative 2 (Alt 2), and possible variations to the provided constructions are explained below.

For Alt 1:

$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ φ {e}_{1} & - φ {e}_{2}\end{matrix} ] , [ \begin{matrix}{e}_{1} & {e}_{1} \\ {e}_{2} & - {e}_{2}\end{matrix} ] , φ = 1 , j . \}$$

For Alt 2, another formulation of Wₙ⁽²⁾ may be either of the following:

$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ {e}_{1} & - {e}_{2}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{2} & - {e}_{1}\end{matrix} ] \} or$$

$${W}_{n}^{( 2 )} ∈ \{ \begin{matrix}[ \begin{matrix}{e}_{1} & {e}_{1 + {i}_{2 , 2}} \\ {e}_{1 + {i}_{2 , 1}} & - {e}_{1 + α ( {i}_{2 , 1} , {i}_{2 , 2} )}\end{matrix} ] , \\ α ( {i}_{2 , 1} , {i}_{2 , 2} ) = mod ( {i}_{2 , 1} + {i}_{2 , 2} , 2 ) , 0 , \leq {i}_{2 , 1} , {i}_{2 , 2} \leq 1\end{matrix} \}$$

It is noteworthy that it is unnecessary to include both

$$[ \begin{matrix}{e}_{1} & {e}_{1} \\ {e}_{1} & - {e}_{1}\end{matrix} ] and [ \begin{matrix}{e}_{1} & {e}_{1} \\ j {e}_{1} & - j {e}_{1}\end{matrix} ]$$

for Wₙ⁽²⁾ as they generate chordal-distance equivalent codewords and either one is sufficient. Additionally, it is unnecessary to include both

$$[ \begin{matrix}{e}_{1} & {e}_{1} \\ {e}_{2} & - {e}_{2}\end{matrix} ] and [ \begin{matrix}{e}_{1} & {e}_{1} \\ j {e}_{2} & - j {e}_{2}\end{matrix} ]$$

for Wₙ⁽²⁾ as they generate chordal-distance equivalent codewords. They may also be included for generation of a uniform formulation of Wₙ⁽²⁾ as follows:

$${W}_{n}^{( 2 )} ∈ \{ [ \begin{matrix}{e}_{1} & {e}_{1} \\ φ {e}_{1} & - φ {e}_{1}\end{matrix} ] , [ \begin{matrix}{e}_{1} & {e}_{1} \\ φ {e}_{2} & - φ {e}_{2}\end{matrix} ] , [ \begin{matrix}{e}_{1} & {e}_{2} \\ φ {e}_{1} & - φ {e}_{2}\end{matrix} ] , φ = 1 , j . \}$$

With the given Wₖ⁽¹⁾, 0≤k≤N₁O₁−1, a Wₙ⁽²⁾ entry may be replaced by replacing every e₁, if any, with e₂ and replacing every e₂, if any, with e₁ for the matrix for that entry. For example:

$$[ \begin{matrix}{e}_{1} \to {e}_{2} & {e}_{1} \to {e}_{2} \\ {e}_{2} \to {e}_{2} & - {e}_{2} \to {e}_{2}\end{matrix} ] ⇒ [ \begin{matrix}{e}_{2} & {e}_{2} \\ {e}_{1} & - {e}_{1}\end{matrix} ]$$

Each of FIG. 8A, FIG. 8B, FIG. 8C, FIG. 8D, FIG. 8E, FIG. 8F, FIG. 8G and FIG. 8H shows example rank 2 codewords with Alt 2 of Construction B in accordance with an implementation of the present disclosure.

### Illustrative Example Construction C

Let N₁=2, N₂=1 and O₁=4, the following may be defined:

PₚWₖ⁽¹⁾Wₙ⁽²⁾

Here, Pₚ (where p=1,2 and 3) may be given by the following:

$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] , {P}_{3} = [ \begin{matrix}1 & 0 & 0 & 0 \\ 0 & 0 & 0 & 1 \\ 0 & 0 & 1 & 0 \\ 0 & 1 & 0 & 0\end{matrix} ] .$$

The definition of Wₖ⁽¹⁾ may be the same as in NR DL 4Tx codebook, given the following:

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}}\end{matrix} ] , \\ {W}_{k}^{( 1 )} = [ \begin{matrix}{B}_{k} & \\ & {B}_{k}\end{matrix} ] , 0 \leq k \leq {N}_{1} {O}_{1} - 1. \\ {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{1} & - {e}_{2}\end{matrix} ] \} \\$$

### Illustrative Implementations

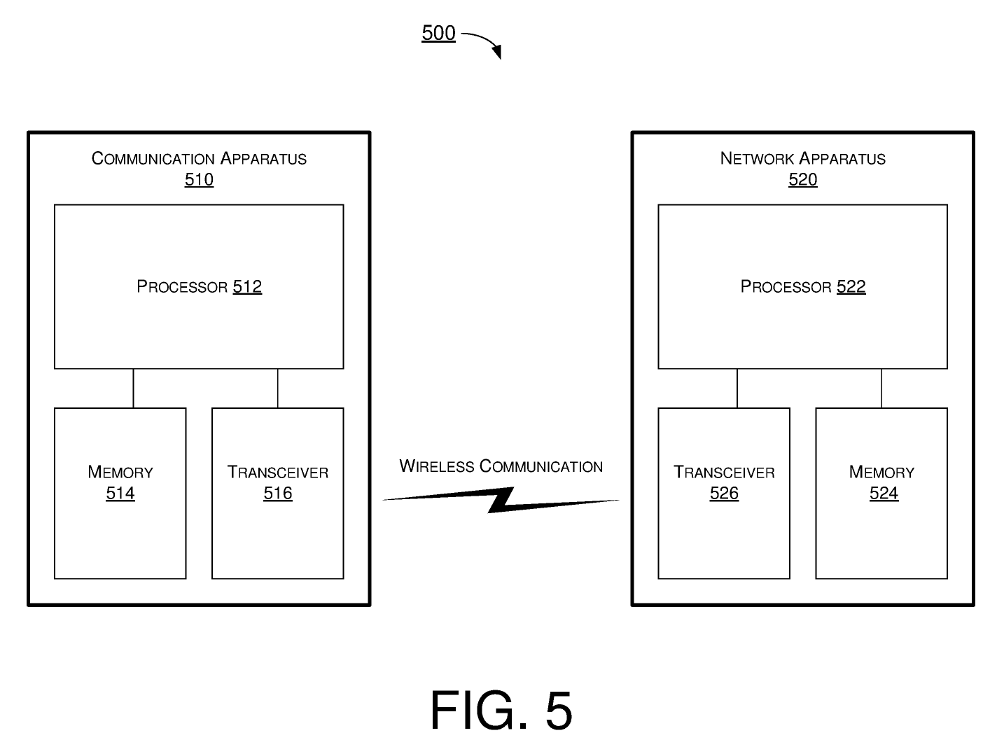

FIG. 5 illustrates an example wireless communication environment 500 in accordance with an implementation of the present disclosure. Wireless communication environment 500 may involve a communication apparatus 510 and a network apparatus 520 in wireless communication with each other. Each of communication apparatus 510 and network apparatus 520 may perform various functions to implement procedures, schemes, techniques, processes and methods described herein pertaining to codebook-based uplink transmission in wireless communications, including the various procedures, scenarios, schemes, solutions, concepts and techniques described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Moreover, communication apparatus 510 may also be a part of a machine type apparatus, which may be an IoT or NB-IoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a TRP, a base station, a small cell, a router or a gateway. For instance, network apparatus 520 may be implemented in an eNodeB in an LTE, LTE-Advanced or LTE-Advanced Pro network or in a gNB in a 5G, NR, IoT or NB-IoT network. Alternatively, network apparatus 520 may be implemented in the form of one or more IC chips such as, for example and without limitation, one or more single-core processors, one or more multi-core processors, one or more RISC processors, or one or more CISC processors.

Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks pertaining to codebook-based uplink transmission in wireless communications in accordance with various implementations of the present disclosure.

In some implementations, communication apparatus 510 may also include a transceiver 516 coupled to processor 512 and capable of wirelessly transmitting and receiving data, signals and information. In some implementations, transceiver 516 may be equipped with a plurality of antenna ports (not shown) such as, for example, four antenna ports. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data, signals and information. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively.

To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node (e.g., gNB or TRP) of a wireless network (e.g., 5G/NR mobile network).

Under various proposed schemes in accordance with the present disclosure, processor 512 of communication apparatus 510 may construct a codebook that includes a plurality of precoders. Additionally, processor 512 may process information using the codebook. Moreover, processor 512 may transmit, via transceiver 516, the processed information to network apparatus 520. In some implementations, in constructing the codebook, processor 512 may select a candidate precoder from a single-stage codebook or a dual-stage codebook. Furthermore, processor 512 may perform a permutation on the candidate precoder.

In some implementations, in performing the permutation on the candidate precoder, processor 512 may perform a plurality of permutations on the candidate precoder to construct the codebook. In some implementations, the plurality of permutations may cover a plurality of mutually unbiased bases, a plurality of codebooks specified in 3GPP specifications, or a combination thereof.

In some implementations, in constructing the codebook, processor 512 may perform numerous operations. For instance, processor 512 may select an original codebook from a plurality of codebooks specified in 3GPP specifications. Additionally, processor 512 may enlarge the original codebook by performing one or more permutations on the original codebook with one or more permutation matrices to obtain the codebook. In some implementations, a feedback overhead of the codebook may remain unchanged compared to a feedback overhead of the original codebook.

In some implementations, in performing the permutation on the candidate precoder, processor 512 may perform numerous operations. For instance, processor 512 may select a permutation matrix from a plurality of permutation matrices. Moreover, processor 512 may apply the permutation matrix to the candidate precoder to enlarge the candidate precoder.

In some implementations, in selecting the permutation matrix, processor 512 may dynamically or semi-statically receive, via transceiver 516, signaling from network apparatus 520 indicating selection of the permutation matrix for constructing the codebook. In some implementations, in receiving the signaling, processor 512 may receive RRC signaling or an MAC CE as part of codebook subset restriction (CSR) or independent of the CSR.

In some implementations, each of the plurality of permutation matrices may correspond to respective one or more antenna placement scenarios or one or more codewords.

In some implementations, the candidate precoder may include a rank 2 precoder.

In some implementations, the codebook may include a rank 1 codebook with a structure of:

Wₖ⁽¹⁾W_{i,j,n}⁽²⁾,

wherein N₁=2, N₂=1, O₁=4 and L=2,

wherein 0≤k≤N₁O₁/2−1=3, 1≤i, j≤2 and 0≤n≤3,

wherein allowed beam selections (i,j)=(1,1), (1,2), (2,1) or (2,2),

wherein ϕₙ takes a value from 1,j, −1, −j,

wherein eᵢ is a L×1 vector with 1 at element i and zero elsewhere, and

wherein

$${φ}_{n} = {e}^{j \frac{π n}{2}} , {u}_{m} = [ \begin{matrix}1 \\ {e}^{j \frac{2 π m}{{O}_{1} {N}_{1}}}\end{matrix} ] , {B}_{n} = [ \begin{matrix}{u}_{n} & {u}_{n + \frac{{O}_{1} {N}_{1}}{2}}\end{matrix} ] , \\ {W}_{n}^{( 1 )} = [ \begin{matrix}{B}_{n} & \\ & {B}_{n}\end{matrix} ] , {W}_{i , j , n}^{( 2 )} = [ \begin{matrix}{e}_{i} \\ {φ}_{n} {e}_{j}\end{matrix} ] .$$

In some implementations, in selecting the candidate precoder, processor 512 may select an NR DL 4Tx codebook. In some implementations, in performing the permutation on the candidate precoder, processor 512 may apply to the NR DL 4Tx codebook a plurality of permutation matrices comprising:

$${P}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$

denoted as permutation (1234);

$${P}_{2} = [ \begin{matrix}1 & 0 & 0 & 0 \\ 0 & 1 & 0 & 0 \\ 0 & 0 & 0 & 1 \\ 0 & 0 & 1 & 0\end{matrix} ] ,$$

denoted as permutation (1243);

$${P}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$

denoted as permutation (1324); and

$${P}_{4} = [ \begin{matrix}1 & 0 & 0 & 0 \\ 0 & 0 & 0 & 1 \\ 0 & 1 & 0 & 0 \\ 0 & 0 & 1 & 0\end{matrix} ] ,$$

denoted as permutation (1423),

wherein

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}}\end{matrix} ] , {W}_{k}^{( 1 )} = [ \begin{matrix}{B}_{k} & \\ & {B}_{k}\end{matrix} ] ,$$

0≤k≤N₁O₁−1, such that

$${W}_{n}^{( 2 )} ∈ \{ [ \begin{matrix}{e}_{1} & {e}_{1} \\ φ {e}_{1} & - φ {e}_{1}\end{matrix} ] , [ \begin{matrix}{e}_{1} & {e}_{2} \\ φ {e}_{1} & - φ {e}_{2}\end{matrix} ] , φ = 1 , j . \}$$

In some implementations, the codebook may include a rank 2 codebook with a structure of:

PₚWₖ⁽¹⁾Wₙ⁽²⁾,

wherein 0≤k≤N₁O₁−1,

wherein N₁=2, N₂=1 and O₁=4,

wherein Pₚ with p=1,2 is defined by:

$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] .$$

wherein a definition of Wₖ⁽¹⁾ is same as in a New Radio (NR) downlink (DL) four-transmitter (4Tx) codebook,

wherein

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$

0≤k≤N₁O₁−1, and

wherein Wₙ⁽²⁾ is defined by either a first alternative (Alt 1) or a second alternative (Alt 2) as follows:

$$\begin{matrix} {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ φ {e}_{1} & - φ {e}_{2}\end{matrix} ] , [ \begin{matrix}{e}_{1} & {e}_{1} \\ {e}_{2} & - {e}_{2}\end{matrix} ] , φ = 1 , j . \} & Alt 1 \\ {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ {e}_{1} & - {e}_{2}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{2} & - {e}_{1}\end{matrix} ] \} \\ such that \\ {W}_{n}^{( 2 )} ∈ \{ [ \begin{matrix}{e}_{1} & {e}_{1 + {i}_{2 , 2}} \\ {e}_{1 + {i}_{2 , 1}} & - {e}_{1 + α ( {i}_{2 , 1} , {i}_{2 , 2} )}\end{matrix} ] , α ( {i}_{2 , 1} , {i}_{2 , 2} ) = mod ( {i}_{2 , 1} + {i}_{2 , 2} , 2 ) , 0 \leq {i}_{2 , 1} , {i}_{2 , 2} \leq 1 \} . & Alt 2\end{matrix}$$

In some implementations, the codebook may include a rank 2 codebook with a structure of:

PₚWₖ⁽¹⁾Wₙ⁽²⁾,

wherein N₁=2, N₂=1 and O₁=4,

wherein Pₚ with p=1,2 and 3 is defined by:

$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] , {P}_{3} = [ \begin{matrix}1 & 0 & 0 & 0 \\ 0 & 0 & 0 & 1 \\ 0 & 0 & 1 & 0 \\ 0 & 1 & 0 & 0\end{matrix} ] .$$

wherein a definition of Wₖ⁽¹⁾ is same as in a New Radio (NR) downlink (DL) four-transmitter (4Tx) codebook,

wherein

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$

0≤k≤N₁O₁−1, and

wherein Wₙ⁽²⁾ is defined as follows:

$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{1} & - {e}_{2}\end{matrix} ] \} .$$

### Illustrative Processes

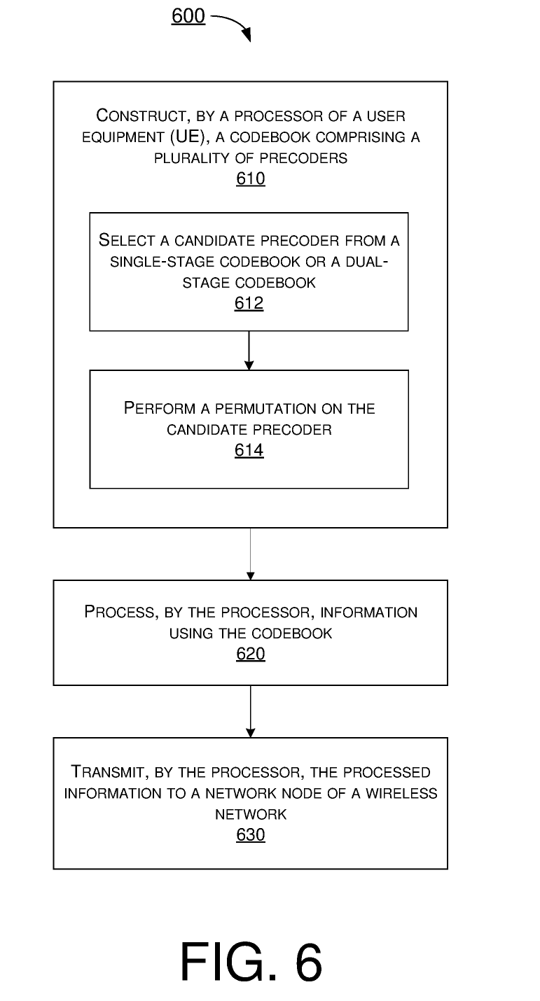

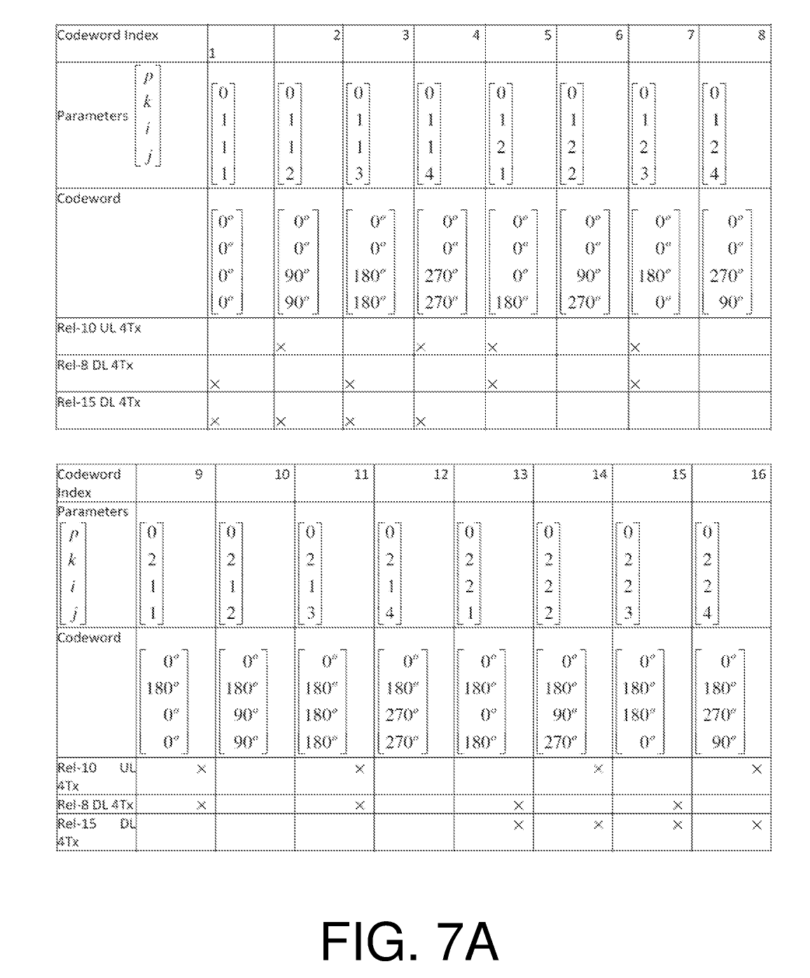

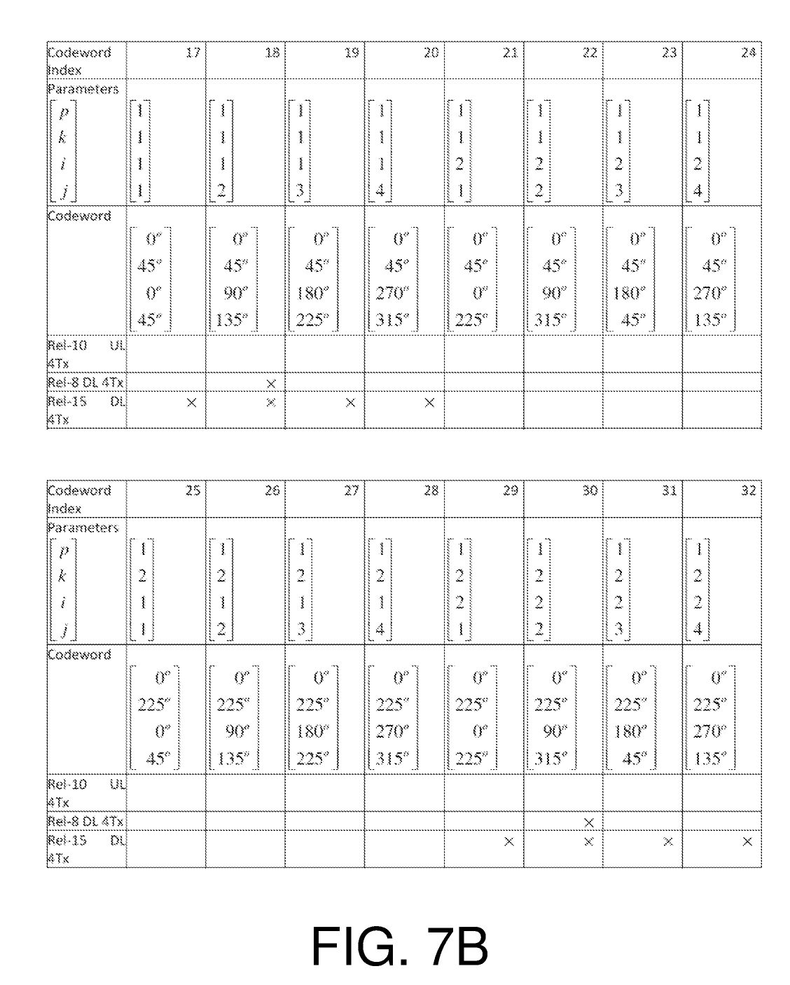

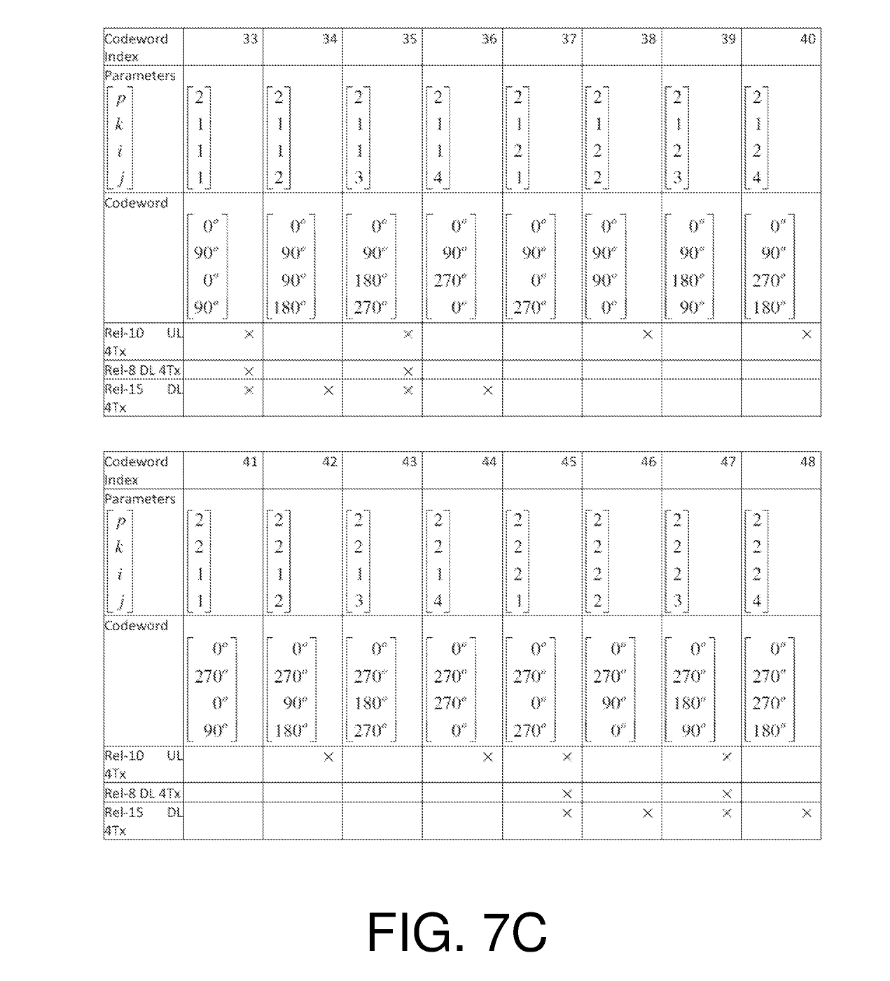

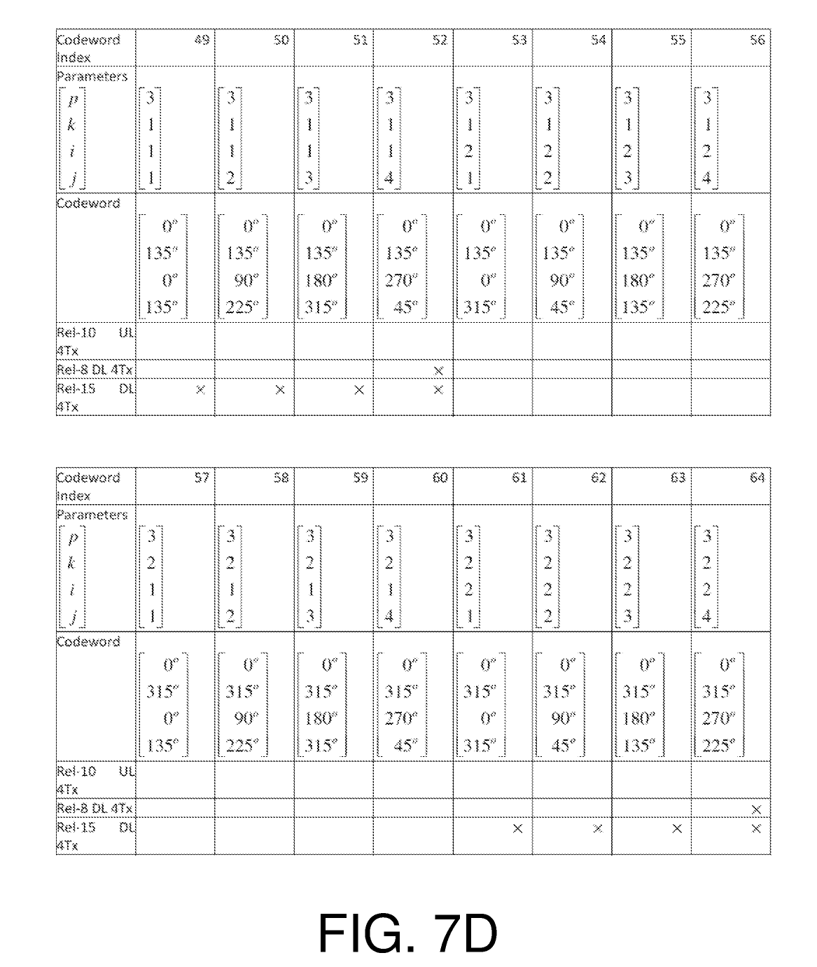

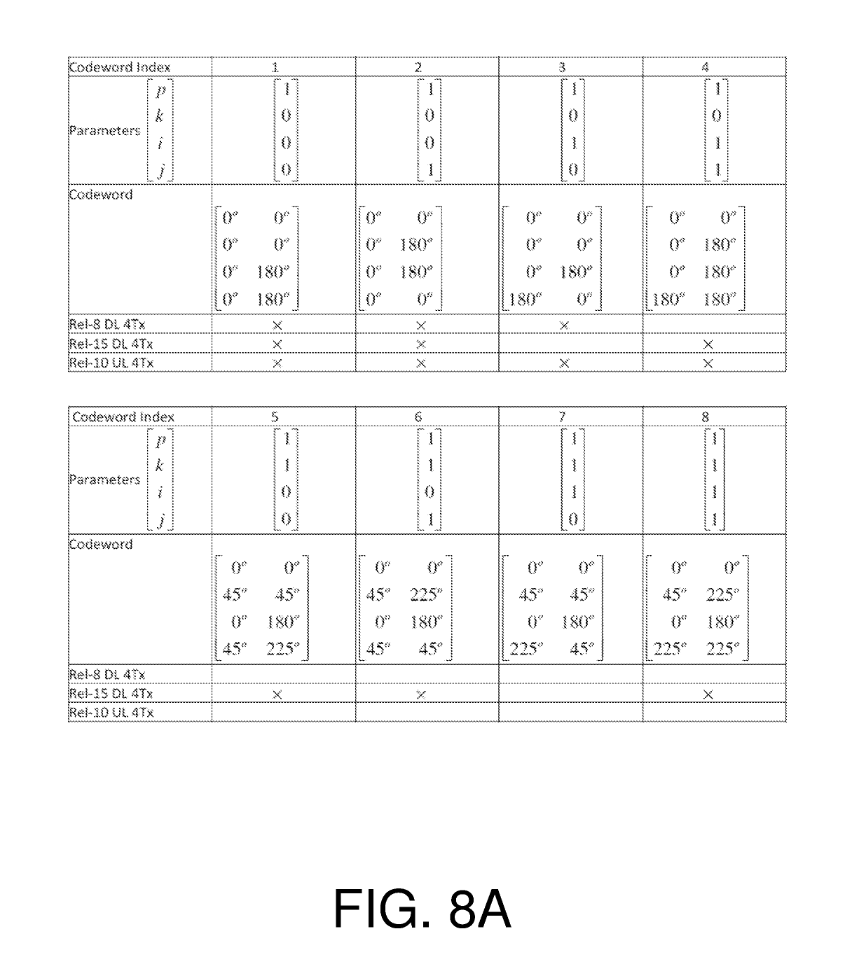

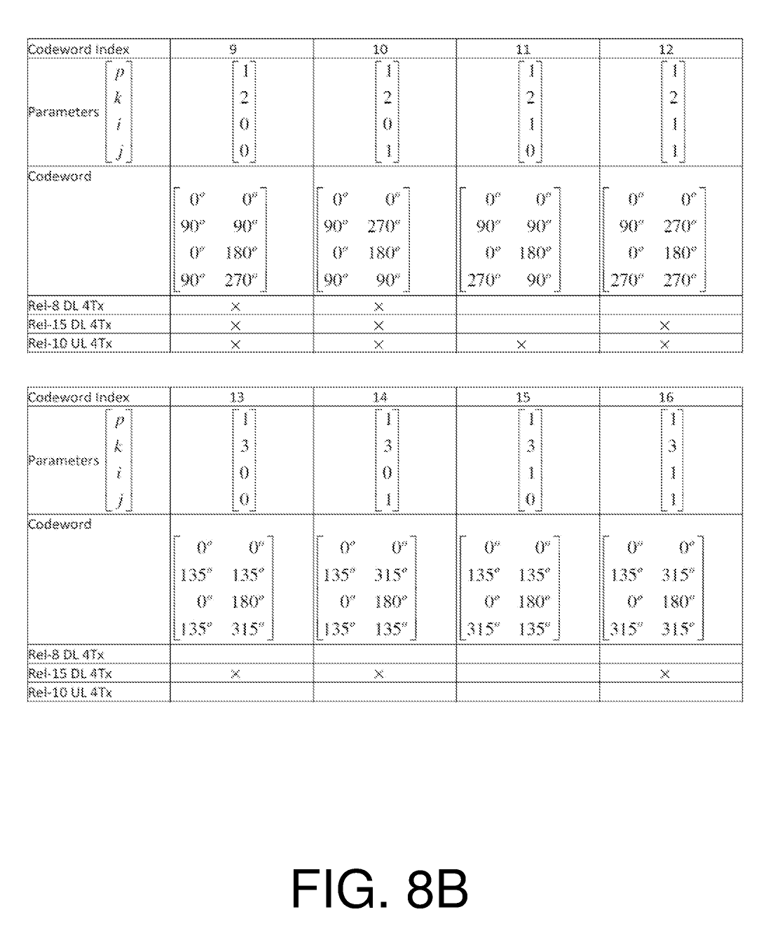

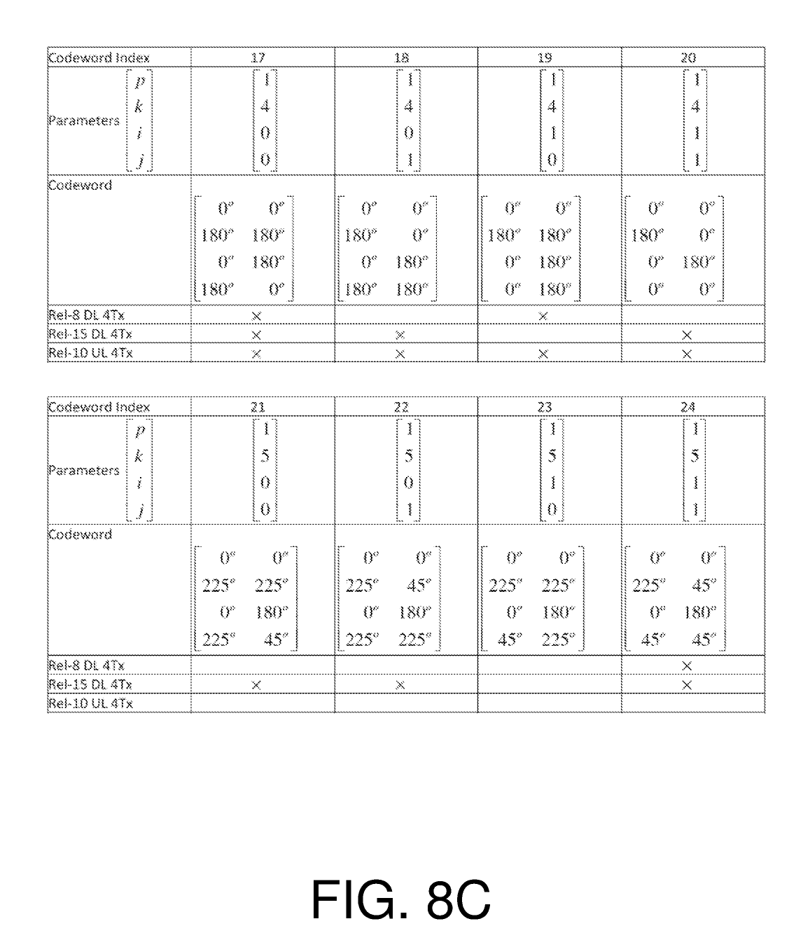

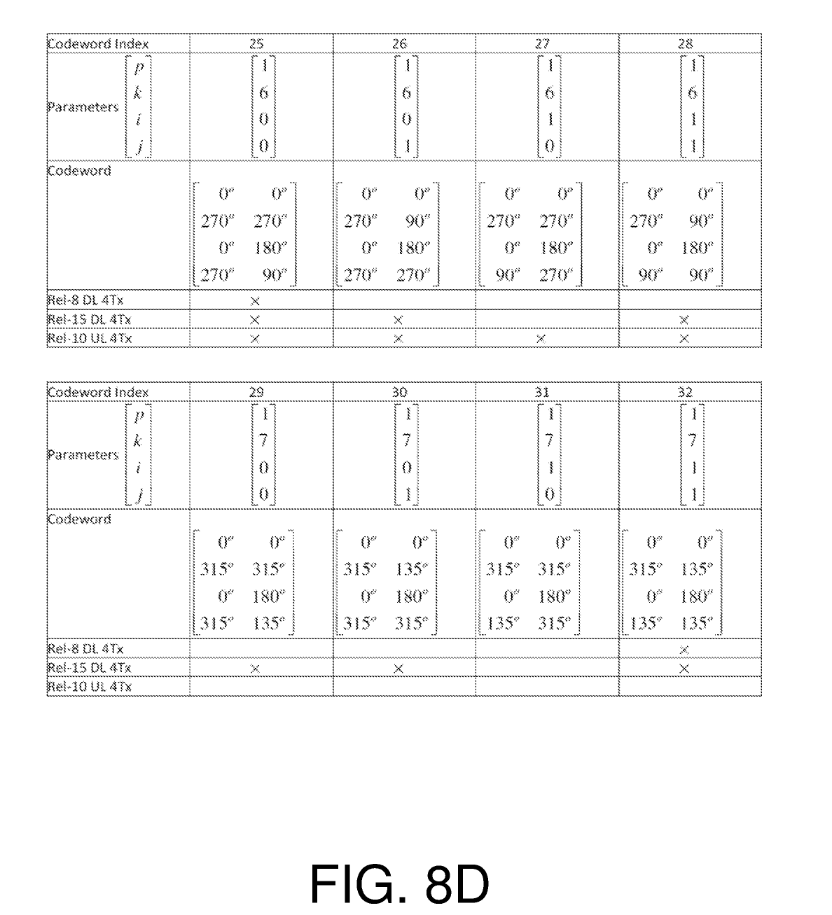

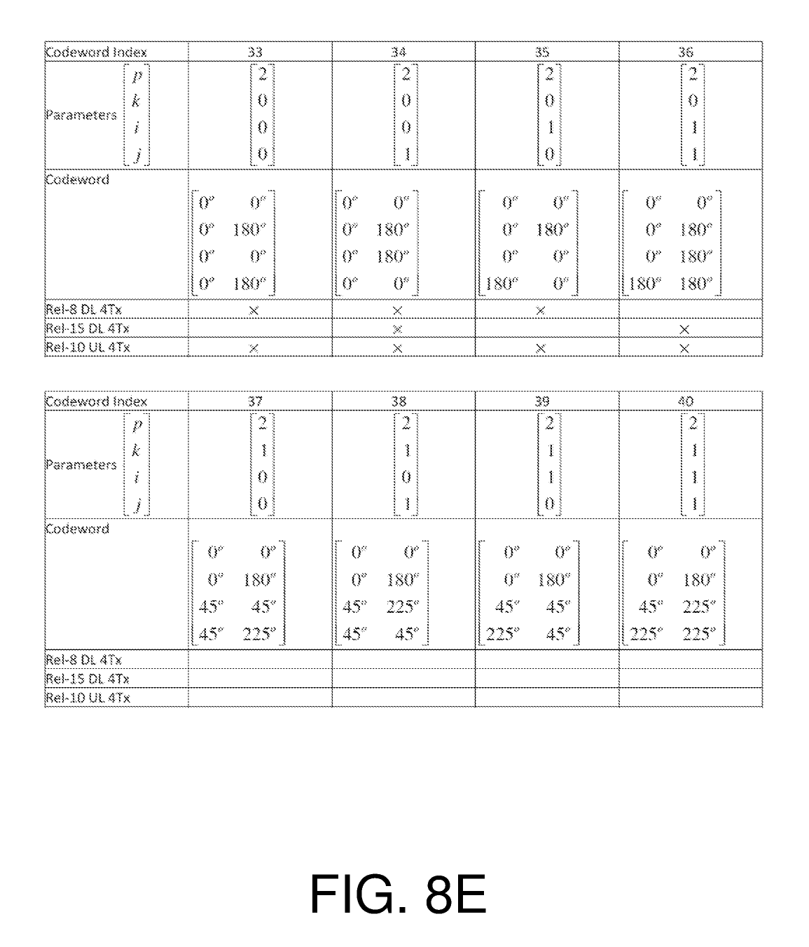

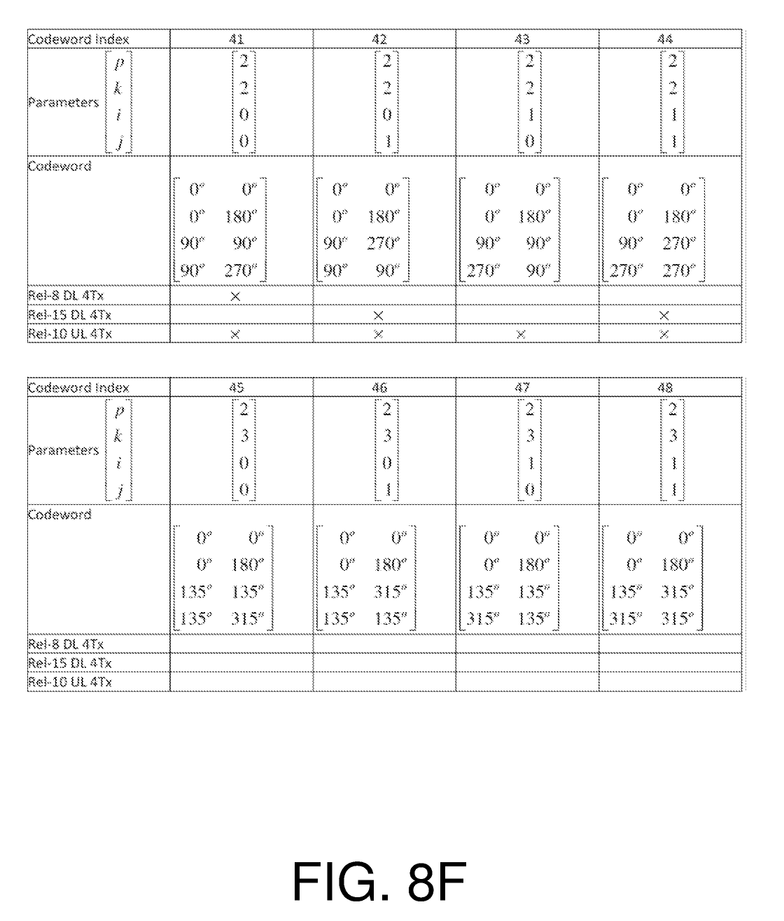

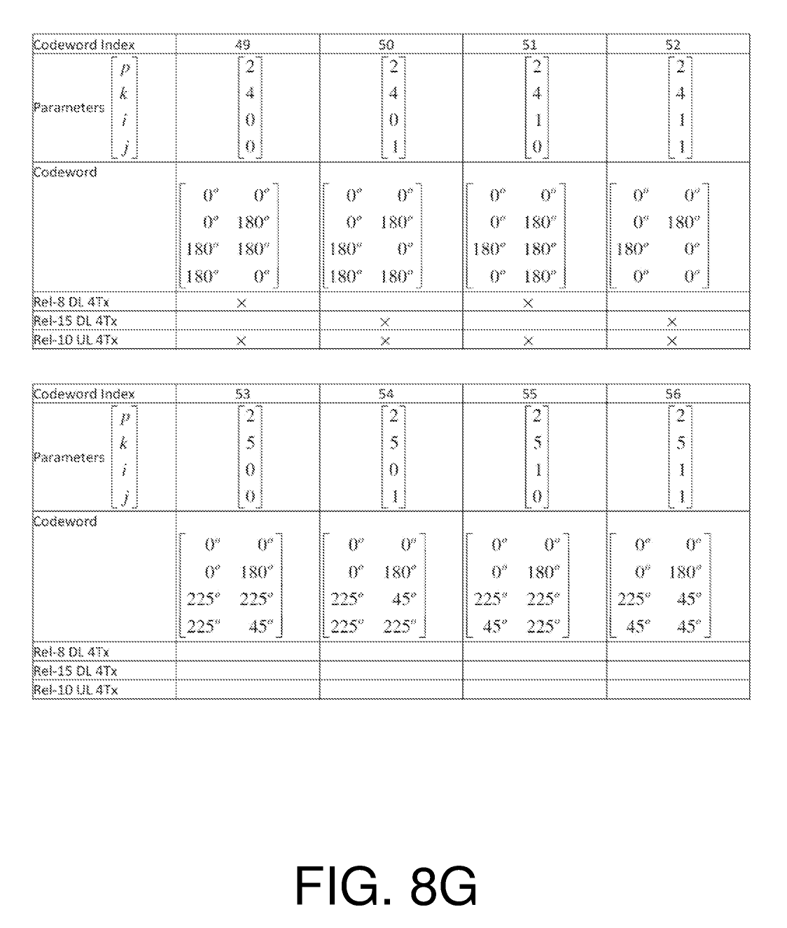

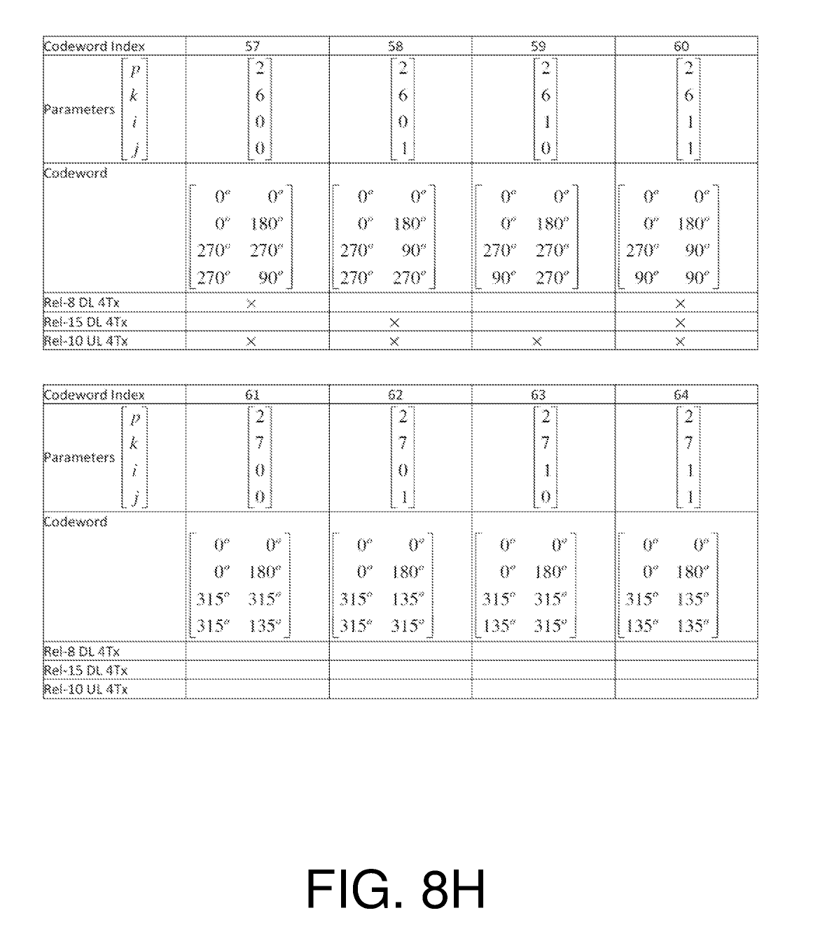

FIG. 6 illustrates an example process 600 in accordance with an implementation of the present disclosure. Process 600 may be an example implementation of the various procedures, scenarios, schemes, solutions, concepts and techniques, or a combination thereof, whether partially or completely, with respect to codebook-based uplink transmission in wireless communications in accordance with the present disclosure. Process 600 may represent an aspect of implementation of features of communication apparatus 510. Process 600 may include one or more operations, actions, or functions as illustrated by one or more of blocks 610, 620 and 630 as well as sub-blocks 612 and 614. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order, and one or more of the blocks of process 600 may be repeated one or more times. Process 600 may be implemented by communication apparatus 510 or any suitable UE or machine type devices. Solely for illustrative purposes and without limitation, process 600 is described below in the context of communication apparatus 510 as a UE and network apparatus 520 as a network node (e.g., gNB) of a wireless network. Process 600 may begin at block 610.

At 610, process 600 may involve processor 512 of communication apparatus 510 constructing a codebook that includes a plurality of precoders. Process 600 may proceed from 610 to 620.

At 620, process 600 may involve processor 512 processing information using the codebook. Process 600 may proceed from 620 to 630.

At 630, process 600 may involve processor 512 transmitting, via transceiver 516, the processed information to network apparatus 520.

In constructing the codebook, process 600 may involve processor 512 performing a number of operations as represented by sub-blocks 612 and 614.

At 612, process 600 may involve processor 512 selecting a candidate precoder from a single-stage codebook or a dual-stage codebook. Process 600 may proceed from 612 to 614.

At 614, process 600 may involve processor 512 performing a permutation on the candidate precoder.

In some implementations, in performing the permutation on the candidate precoder, process 600 may involve processor 512 performing a plurality of permutations on the candidate precoder to construct the codebook. In some implementations, the plurality of permutations may cover a plurality of mutually unbiased bases, a plurality of codebooks specified in 3GPP specifications, or a combination thereof.

In some implementations, in constructing the codebook, process 600 may involve processor 512 performing numerous operations. For instance, process 600 may involve processor 512 selecting an original codebook from a plurality of codebooks specified in 3GPP specifications. Additionally, process 600 may involve processor 512 enlarging the original codebook by performing one or more permutations on the original codebook with one or more permutation matrices to obtain the codebook. In some implementations, a feedback overhead of the codebook may remain unchanged compared to a feedback overhead of the original codebook.

In some implementations, in performing the permutation on the candidate precoder, process 600 may involve processor 512 performing numerous operations. For instance, process 600 may involve processor 512 selecting a permutation matrix from a plurality of permutation matrices. Moreover, process 600 may involve processor 512 applying the permutation matrix to the candidate precoder to enlarge the candidate precoder.

In some implementations, in selecting the permutation matrix, process 600 may involve processor 512 dynamically or semi-statically receiving, via transceiver 516, signaling from network apparatus 520 indicating selection of the permutation matrix for constructing the codebook. In some implementations, in receiving the signaling, process 600 may involve processor 512 receiving RRC signaling or an MAC CE as part of codebook subset restriction (CSR) or independent of the CSR.

In some implementations, each of the plurality of permutation matrices may correspond to respective one or more antenna placement scenarios or one or more codewords.

In some implementations, the candidate precoder may include a rank 2 precoder.

In some implementations, the codebook may include a rank 1 codebook with a structure of:

Wₖ⁽¹⁾W_{i,j,n}⁽²⁾,

wherein N₁=2, N₂=1, O₁=4 and L=2,

wherein 0≤k≤N₁O₁/2−1=3, 1≤i, j≤2 and 0≤n≤3,

wherein allowed beam selections (i,j)=(1,1), (1,2), (2,1) or (2,2),

wherein ϕₙ takes a value from 1, j, −1, −j,

wherein eᵢ is a L×1 vector with 1 at element i and zero elsewhere, and

wherein

$${φ}_{n} = {e}^{j \frac{π n}{2}} , {u}_{m} = [ \begin{matrix}1 \\ {e}^{j \frac{2 π m}{{O}_{1} {N}_{1}}}\end{matrix} ] , {B}_{n} = [ \begin{matrix}{u}_{n} & {u}_{n + \frac{{O}_{1} {N}_{1}}{2}} ]\end{matrix} , \\ {W}_{n}^{( 1 )} = [ \begin{matrix}{B}_{n} & \\ & {B}_{n}\end{matrix} ] , {W}_{i , j , n}^{( 2 )} = [ \begin{matrix}{e}_{i} \\ {φ}_{n} {e}_{j}\end{matrix} ] .$$

In some implementations, in selecting the candidate precoder, process 600 may involve processor 512 selecting an NR DL 4Tx codebook. In some implementations, in performing the permutation on the candidate precoder, process 600 may involve processor 512 applying to the NR DL 4Tx codebook a plurality of permutation matrices comprising:

$${P}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$

denoted as permutation (1234);

$${P}_{2} = [ \begin{matrix}1 & 0 & 0 & 0 \\ 0 & 1 & 0 & 0 \\ 0 & 0 & 0 & 1 \\ 0 & 0 & 1 & 0\end{matrix} ] ,$$

denoted as permutation (1243);

$${P}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$

denoted as permutation (1324);

$${P}_{4} = [ \begin{matrix}1 & 0 & 0 & 0 \\ 0 & 0 & 0 & 1 \\ 0 & 1 & 0 & 0 \\ 0 & 0 & 1 & 0\end{matrix} ] ,$$

denoted as permutation (1423),

wherein

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ]\end{matrix} , {W}_{k}^{( 1 )} = [ \begin{matrix}{B}_{k} & \\ & {B}_{k}\end{matrix} ] ,$$

0≤k≤N₁O₁−1, such that

$${W}_{n}^{( 2 )} ∈ \{ [ \begin{matrix}{e}_{1} & {e}_{1} \\ φ {e}_{1} & - φ {e}_{1}\end{matrix} ] , [ \begin{matrix}{e}_{1} & {e}_{2} \\ φ {e}_{1} & - φ {e}_{2}\end{matrix} ] , φ = 1 , j . \} .$$

In some implementations, the codebook may include a rank 2 codebook with a structure of:

PₚWₖ⁽¹⁾Wₙ⁽²⁾,

wherein 0≤k≤N₁O₁−1,

wherein N₁=2, N₂=1 and O₁=4,

wherein Pₚ with p=1,2 is defined by:

$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] .$$

wherein a definition of Wₖ⁽¹⁾ is same as in a New Radio (NR) downlink (DL) four-transmitter (4Tx) codebook,

wherein

$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$

0≤k≤N₁O₁−1, and

wherein Wₙ⁽²⁾ is defined by either a first alternative (Alt 1) or a second alternative (Alt 2) as follows:

$$Alt 1 {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ φ {e}_{1} & - φ {e}_{2}\end{matrix} ] , [ \begin{matrix}{e}_{1} & {e}_{1} \\ {e}_{2} & - {e}_{2}\end{matrix} ] , φ = 1 , j . \}$$

$$Alt 2 {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ {e}_{1} & - {e}_{2}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{2} & - {e}_{1}\end{matrix} ] \}$$

$$such that$$

$${W}_{n}^{( 2 )} ∈ \{ [ \begin{matrix}{e}_{1} & {e}_{1 + {i}_{2 , 2}} \\ {e}_{1 + {i}_{2 , 1}} & - {e}_{1 + α ( {i}_{2 , 1} , {i}_{2 , 2} )}\end{matrix} ] , α ( {i}_{2 , 1} , {i}_{2 , 2} ) = mod ( {i}_{2 , 1} + {i}_{2 , 2} , 2 ) , 0 \leq {i}_{2 , 1} , {i}_{2 , 2} \leq 1 \} .$$

In some implementations, the codebook may include a rank 2 codebook with a structure of:

PₚWₖ⁽¹⁾Wₙ⁽²⁾,

wherein N₁=2, N₂=1 and O₁=4,

wherein Pₚ with p=1,2 and 3 is defined by:

$${P}_{1} = [ \begin{matrix}1 & & & \\ & 1 & & \\ & & 1 & \\ & & & 1\end{matrix} ] , \\ {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] , \\ {P}_{3} = [ \begin{matrix}1 & 0 & 0 & 0 \\ 0 & 0 & 0 & 1 \\ 0 & 0 & 1 & 0 \\ 0 & 1 & 0 & 0\end{matrix} ] .$$

wherein a definition of Wₖ⁽¹⁾ is same as in a New Radio (NR) downlink (DL) four-transmitter (4Tx) codebook,

wherein

$${u}_{m} = [ \begin{matrix}1 \\ {e}^{j \frac{2 π m}{{O}_{1} {N}_{1}}}\end{matrix} ] , {B}_{k} = [ {u}_{k} {u}_{k + \frac{{O}_{1} {N}_{1}}{2}} ] , and$$

$${W}_{k}^{( 1 )} = [ \begin{matrix}{B}_{k} & \\ & {B}_{k}\end{matrix} ] ,$$

0≤k≤N₁O₁−1, and

wherein Wₙ⁽²⁾ is defined as follows:

$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{1} & - {e}_{2}\end{matrix} ] \} .$$

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
constructing, by a processor of a user equipment (UE), a codebook comprising a plurality of precoders;
processing, by the processor, information using the codebook; and
transmitting, by the processor, the processed information to a network node of a wireless network,
wherein the constructing of the codebook comprises:
selecting a candidate precoder from a single-stage codebook or a dual-stage codebook; and
performing a permutation on the candidate precoder.

2. The method of claim 1, wherein the performing of the permutation on the candidate precoder comprises performing a plurality of permutations on the candidate precoder to construct the codebook, and wherein the plurality of permutations cover a plurality of mutually unbiased bases, a plurality of codebooks specified in 3^{rd}-Generation Partnership Project (3GPP) specifications, or a combination thereof.

3. The method of claim 1, wherein the constructing of the codebook comprises:
selecting an original codebook from a plurality of codebooks specified in 3^{rd}-Generation Partnership Project (3GPP) specifications; and
enlarging the original codebook by performing one or more permutations on the original codebook with one or more permutation matrices to obtain the codebook,
wherein a feedback overhead of the codebook remains unchanged compared to a feedback overhead of the original codebook.

4. The method of claim 1, wherein the performing of the permutation on the candidate precoder comprises:
selecting a permutation matrix from a plurality of permutation matrices; and
applying the permutation matrix to the candidate precoder to enlarge the candidate precoder.

5. The method of claim 4, wherein the selecting of the permutation matrix comprises dynamically or semi-statically receiving signaling from the network node indicating selection of the permutation matrix for constructing the codebook.

6. The method of claim 5, wherein the receiving of the signaling comprises receiving radio resource control (RRC) signaling or a media access control (MAC) control element (CE) as part of codebook subset restriction (CSR) or independent of the CSR.

7. The method of claim 4, wherein each of the plurality of permutation matrices corresponds to respective one or more antenna placement scenarios or one or more codewords.

8. The method of claim 1, wherein the candidate precoder comprises a rank 2 precoder.

9. The method of claim 1, wherein the codebook comprises a rank 1 codebook with a structure of:
Wₖ⁽¹⁾W_{i,j,n}⁽²⁾,
wherein N₁=2, N₂=1, O₁=4 and L=2,
wherein 0≤k≤N₁O₁/2−1=3, 1≤i, j≤2 and 0≤n≤3,
wherein allowed beam selections (i,j)=(1,1), (1,2), (2,1) or (2,2),
wherein ϕₙ takes a value from 1, j, −1, −j,
wherein eᵢ is a L×1 vector with 1 at element i and zero elsewhere, and
wherein
$${φ}_{n} = {e}^{j \frac{π n}{2}} , {u}_{m} = [ \begin{matrix}1 \\ {e}^{j \frac{2 π m}{{O}_{1} {N}_{1}}}\end{matrix} ] , {B}_{n} = [ {u}_{n} {u}_{n + \frac{{O}_{1} {N}_{1}}{2}} ] , \\ {W}_{n}^{( 1 )} = [ \begin{matrix}{B}_{n} & \\ & {B}_{n}\end{matrix} ] , {W}_{i , j , n}^{( 2 )} = [ \begin{matrix}{e}_{i} \\ {φ}_{n} {e}_{j}\end{matrix} ] .$$

10. The method of claim 1, wherein the selecting of the candidate precoder comprises selecting a New Radio (NR) downlink (DL) four-transmitter (4Tx) codebook, and wherein the performing of the permutation on the candidate precoder comprises applying to the NR DL 4Tx codebook a plurality of permutation matrices comprising:
$${P}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$
denoted as permutation (1234);
$${P}_{2} = [ \begin{matrix}1 & 0 & 0 & 0 \\ 0 & 1 & 0 & 0 \\ 0 & 0 & 0 & 1 \\ 0 & 0 & 1 & 0\end{matrix} ] ,$$
denoted as permutation (1243);
$${P}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$
denoted as permutation (1324); and
$${P}_{4} = [ \begin{matrix}1 & 0 & 0 & 0 \\ 0 & 0 & 0 & 1 \\ 0 & 1 & 0 & 0 \\ 0 & 0 & 1 & 0\end{matrix} ] ,$$
denoted as permutation (1423),
wherein
$${u}_{m} = [ \begin{matrix}1 \\ {e}^{j \frac{2 π m}{{O}_{1} {N}_{1}}}\end{matrix} ] , {B}_{k} = [ {u}_{k} {u}_{k + \frac{{O}_{1} {N}_{1}}{2}} ] , {W}_{k}^{( 1 )} = [ \begin{matrix}{B}_{k} & \\ & {B}_{k}\end{matrix} ] ,$$
0≤k≤N₁O₁−1, such that
$${W}_{n}^{( 2 )} ∈ \{ [ \begin{matrix}{e}_{1} & {e}_{2} \\ φ {e}_{1} & - φ {e}_{1}\end{matrix} ] , [ \begin{matrix}{e}_{1} & {e}_{2} \\ φ {e}_{1} & - φ {e}_{2}\end{matrix} ] , φ = 1 , j . \} .$$

11. The method of claim 1, wherein the codebook comprises a rank 2 codebook with a structure of:
PₚWₖ⁽¹⁾Wₙ⁽²⁾,
wherein 0≤k≤N₁O₁−1,
wherein N₁=2, N₂=1 and O₁=4,
wherein Pₚ with p=1,2 is defined by:
$${P}_{1} = [ \begin{matrix}1 & & & \\ & 1 & & \\ & & 1 & \\ & & & 1\end{matrix} ] , \\ {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] .$$
wherein a definition of Wₖ⁽¹⁾ is same as in a New Radio (NR) downlink (DL) four-transmitter (4Tx) codebook,
wherein
$${u}_{m} = [ \begin{matrix}1 \\ {e}^{j \frac{2 π m}{{O}_{1} {N}_{1}}}\end{matrix} ] , {B}_{k} = [ {u}_{k} {u}_{k + \frac{{O}_{1} {N}_{1}}{2}} ] , and {W}_{k}^{( 1 )} = [ \begin{matrix}{B}_{k} & \\ & {B}_{k}\end{matrix} ] ,$$
0≤k≤N₁O₁−1, and
wherein Wₙ⁽²⁾ is defined by either a first alternative (Alt 1) or a second alternative (Alt 2) as follows:
$$Alt 1 {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ φ {e}_{1} & - φ {e}_{2}\end{matrix} ] , [ \begin{matrix}{e}_{1} & {e}_{1} \\ {e}_{2} & - {e}_{2}\end{matrix} ] , φ = 1 , j . \}$$
$$Alt 2 {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ {e}_{1} & - {e}_{2}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{2} & - {e}_{1}\end{matrix} ] \}$$
$$such that$$
$${W}_{n}^{( 2 )} ∈ \{ [ \begin{matrix}{e}_{1} & {e}_{1 + {i}_{2 , 2}} \\ {e}_{1 + {i}_{2 , 1}} & - {e}_{1 + α ( {i}_{2 , 1} , {i}_{2 , 2} )}\end{matrix} ] , α ( {i}_{2 , 1} , {i}_{2 , 2} ) = mod ( {i}_{2 , 1} + {i}_{2 , 2} , 2 ) , 0 \leq {i}_{2 , 1} , {i}_{2 , 2} \leq 1 \} .$$

12. The method of claim 1, wherein the codebook comprises a rank 2 codebook with a structure of:
PₚWₖ⁽¹⁾Wₙ⁽²⁾,
wherein N₁=2, N₂=1 and O₁=4,
wherein Pₚ with p=1,2 and 3 is defined by:
$${P}_{1} = [ \begin{matrix}1 & & & \\ & 1 & & \\ & & 1 & \\ & & & 1\end{matrix} ] , \\ {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] , \\ {P}_{3} = [ \begin{matrix}1 & 0 & 0 & 0 \\ 0 & 0 & 0 & 1 \\ 0 & 0 & 1 & 0 \\ 0 & 1 & 0 & 0\end{matrix} ] .$$
wherein a definition of Wₖ⁽¹⁾ is same as in a New Radio (NR) downlink (DL) four-transmitter (4Tx) codebook,
wherein
$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$
0≤k≤N₁O₁−1, and
wherein Wₙ⁽²⁾ is defined as follows:
$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{1} & - {e}_{2}\end{matrix} ] \} .$$

13. An apparatus, comprising:
a transceiver capable of wireless communicating with a network node of a wireless network; and
a processor coupled to the transceiver, the processor capable of:
constructing a codebook comprising a plurality of precoders;
processing information using the codebook; and
transmitting, via the transceiver, the processed information to a network node of a wireless network,
wherein in constructing the codebook the processor is capable of:
selecting a candidate precoder from a single-stage codebook or a dual-stage codebook; and
performing a permutation on the candidate precoder.

14. The apparatus of claim 13, wherein in performing the permutation on the candidate precoder the processor is capable of performing a plurality of permutations on the candidate precoder to construct the codebook, and wherein the plurality of permutations cover a plurality of mutually unbiased bases, a plurality of codebooks specified in 3^{rd}-Generation Partnership Project (3GPP) specifications, or a combination thereof.

15. The apparatus of claim 13, wherein in constructing the codebook the processor is capable of:
selecting an original codebook from a plurality of codebooks specified in 3^{rd}-Generation Partnership Project (3GPP) specifications; and
enlarging the original codebook by performing one or more permutations on the original codebook with one or more permutation matrices to obtain the codebook,
wherein a feedback overhead of the codebook remains unchanged compared to a feedback overhead of the original codebook.

16. The apparatus of claim 13, wherein in performing the permutation on the candidate precoder the processor is capable of:
selecting a permutation matrix from a plurality of permutation matrices; and
applying the permutation matrix to the candidate precoder to enlarge the candidate precoder,
wherein in selecting the permutation matrix the processor is capable of dynamically or semi-statically receiving, via the transceiver, signaling from the network node indicating selection of the permutation matrix for constructing the codebook, and
wherein in receiving the signaling the processor is capable of receiving radio resource control (RRC) signaling or a media access control (MAC) control element (CE) as part of codebook subset restriction (CSR) or independent of the CSR.

17. The apparatus of claim 13, wherein the codebook comprises a rank 1 codebook with a structure of:
Wₖ⁽¹⁾W_{i,j,n}⁽²⁾,
wherein N₁=2, N₂=1, O₁=4 and L=2,
wherein 0≤k≤N₁O₁/2−1=3, 1≤i, j≤2 and 0≤n≤3,
wherein allowed beam selections (i,j)=(1,1), (1,2), (2,1) or (2,2),
wherein ϕₙ takes a value from 1,j, −1, −j,
wherein eᵢ is a L×1 vector with 1 at element i and zero elsewhere, and
wherein
$${φ}_{n} = {e}^{j \frac{π n}{2}} , {u}_{m} = [ \begin{matrix}1 \\ {e}^{j \frac{2 π m}{{O}_{1} {N}_{1}}}\end{matrix} ] , {B}_{n} = [ \begin{matrix}{u}_{n} & {u}_{n + \frac{{O}_{1} {N}_{1}}{2}} ] ,\end{matrix} \\ {W}_{n}^{( 1 )} = [ \begin{matrix}{B}_{n} & \\ & {B}_{n}\end{matrix} ] , {W}_{i , j , n}^{( 2 )} = [ \begin{matrix}{e}_{i} \\ {φ}_{n} {e}_{j}\end{matrix} ] .$$

18. The apparatus of claim 13, wherein in selecting the candidate precoder the processor is capable of selecting a New Radio (NR) downlink (DL) four-transmitter (4Tx) codebook, and wherein in performing the permutation on the candidate precoder the processor is capable of applying to the NR DL 4Tx codebook a plurality of permutation matrices comprising:
$${P}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$
denoted as permutation (1234);
$${P}_{2} = [ \begin{matrix}1 & 0 & 0 & 0 \\ 0 & 1 & 0 & 0 \\ 0 & 0 & 0 & 1 \\ 0 & 0 & 1 & 0\end{matrix} ] ,$$
denoted as permutation (1243);
$${P}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$
denoted as permutation (1324); and
$${P}_{4} = [ \begin{matrix}1 & 0 & 0 & 0 \\ 0 & 0 & 0 & 1 \\ 0 & 1 & 0 & 0 \\ 0 & 0 & 1 & 0\end{matrix} ] ,$$
denoted as permutation (1423),
wherein
$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} {W}_{k}^{( 1 )} = [ \begin{matrix}{B}_{k} & \\ & {B}_{k}\end{matrix} ] ,$$
0≤k≤N₁O₁−1, such that
$${W}_{n}^{( 2 )} ∈ \{ [ \begin{matrix}{e}_{1} & {e}_{1} \\ φ {e}_{1} & - φ {e}_{1}\end{matrix} ] , [ \begin{matrix}{e}_{1} & {e}_{2} \\ φ {e}_{1} & - φ {e}_{2}\end{matrix} ] , φ = 1 , j . \} .$$

19. The apparatus of claim 13, wherein the codebook comprises a rank 2 codebook with a structure of:
PₚWₖ⁽¹⁾Wₙ⁽²⁾,
wherein 0≤k≤N₁O₁−1,
wherein N₁=2, N₂=1 and O₁=4,
wherein Pₚ with p=1,2 is defined by:
$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] .$$
wherein a definition of Wₖ⁽¹⁾ is same as in a New Radio (NR) downlink (DL) four-transmitter (4Tx) codebook,
wherein
$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$
0≤k≤N₁O₁−1, and
wherein Wₙ⁽²⁾ is defined by either a first alternative (Alt 1) or a second alternative (Alt 2) as follows:
$$\begin{matrix} {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ φ {e}_{1} & - φ {e}_{2}\end{matrix} ] , [ \begin{matrix}{e}_{1} & {e}_{1} \\ {e}_{2} & - {e}_{2}\end{matrix} ] , φ = 1 , j . \} \\ & Alt 1 \\ {W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{2} \\ {e}_{1} & - {e}_{2}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{2} & - {e}_{1}\end{matrix} ] \} \\ such that \\ {W}_{n}^{( 2 )} ∈ \{ [ \begin{matrix}{e}_{1} & {e}_{1 + {i}_{2 , 2}} \\ {e}_{1 + {i}_{2 , 1}} & - {e}_{1 + α ( {i}_{2 , 1} , {i}_{2 , 2} )}\end{matrix} ] , α ( {i}_{2 , 1} , {i}_{2 , 2} ) = mod ( {i}_{2 , 1} + {i}_{2 , 2} , 2 ) , 0 \leq {i}_{2 , 1} , {i}_{2 , 2} \leq 1 \} . & Alt 2\end{matrix}$$

20. The apparatus of claim 13, wherein the codebook comprises a rank 2 codebook with a structure of:
PₚWₖ⁽¹⁾Wₙ⁽²⁾,
wherein N₁=2, N₂=1 and O₁=4,
wherein Pₚ with p=1,2 and 3 is defined by:
$${P}_{1} = [ \begin{matrix}1 & & & \\ & 1 & & \\ & & 1 & \\ & & & 1\end{matrix} ] , {P}_{2} = [ \begin{matrix}1 & 0 & 0 & 0 \\ 0 & 0 & 1 & 0 \\ 0 & 1 & 0 & 0 \\ 0 & 0 & 0 & 1\end{matrix} ] , {P}_{3} = [ \begin{matrix}1 & 0 & 0 & 0 \\ 0 & 0 & 0 & 1 \\ 0 & 0 & 1 & 0 \\ 0 & 1 & 0 & 0\end{matrix} ] .$$
wherein a definition of Wₖ⁽¹⁾ is same as in a New Radio (NR) downlink (DL) four-transmitter (4Tx) codebook,
wherein
$${u}_{m} = [ \begin{matrix}1 \\ {e}^{j \frac{2 π m}{{O}_{1} {N}_{1}}}\end{matrix} ] , {B}_{k} = [ \begin{matrix}{u}_{k} & {u}_{k + \frac{{O}_{1} {N}_{1}}{2}} ] , \end{matrix} and {W}_{k}^{( 1 )} = [ \begin{matrix}{B}_{k} & \\ & {B}_{k}\end{matrix} ] ,$$
0≤k≤N₁O₁, −1, and
wherein Wₙ⁽²⁾ is defined as follows:
$${W}_{n}^{( 2 )} ∈ \{ [ \begin{matrix}{e}_{1} & {e}_{1} \\ {e}_{1} & - {e}_{1}\end{matrix} ] , [ \begin{matrix}{e}_{1} & {e}_{1} \\ {e}_{2} & - {e}_{2}\end{matrix} ] , [ \begin{matrix}{e}_{1} & {e}_{2} \\ {e}_{1} & - {e}_{2}\end{matrix} ] \} .$$
